(19) United States
(12) Patent Application Publication
(10) Pub. No.: US 2012/0203637 A1
(43) Pub. Date: Aug. 9, 2012

(54) METHOD AND SYSTEM FOR PROVIDING CONSUMER-TARGETED ADVERTISEMENT INFORMATION

(76) Inventors: Cheolho NAM, Seoul (KR); Eunho NAM, Hwaseong-si (KR)

(21) Appl. No.: 13/367,379

(22) Filed: Feb. 7, 2012

Related U.S. Application Data
(60) Provisional application No. 61/440,829, filed on Feb. 8, 2011.

(30) Foreign Application Priority Data
Aug. 18, 2011 (KR) 10-2011-0082055

(51) Int. Cl. G06Q 30/02

(52) U.S. Cl. 705/14.55

(57) ABSTRACT

A method of providing consumer-targeted advertisement information through a mobile network is introduced with the present invention. The method includes receiving a plurality of advertisement information from one or more advertisers and pre-storing the advertisement information in a storage, the advertisement information including sale information of a product or service, receiving a first request from a consumer via a mobile device connected to the network for downloading an advertisement application, transmitting the advertisement application to the mobile device through the mobile network, storing consumer information in the storage, generating first consumer-targeted advertisement information by filtering the plurality of advertisement information based on the stored consumer information, and transmitting the first consumer-targeted advertisement information to the mobile device.

This application claims the benefit of U.S. Provisional Application No. 61/440,829, filed on Feb. 8, 2011 and claims the benefit of Korean Patent Application No. 10-2011-0082055, filed on Aug. 18, 2011. The foregoing applications are incorporated by reference herein in their entireties.

### BACKGROUND

The present invention generally relates to providing advertisement to consumers. More specifically, the present invention is related to a method and system for consumer-targeted advertisement, providing sale information to the consumers. In a conventional advertisement system, the advertiser pays advertising fee to the advertisement provider and the advertisement provider advertises through mediums including but not limited to newspaper, magazine, TV broadcasting, cable network, internet, mobile device, and so forth. By paying the advertisement fee to the advertisement provider, the advertiser's advertisements are advertised through the advertisement provider's medium and the public gets to see and know about the advertisement. However, in the conventional advertisement system, the downfall is that it is hard for the advertiser to know who their advertisement is targeted to. In other words, companies spend substantial amount of advertisement fee to advertise their product not knowing exactly who are viewing their advertisement. Therefore, the conventional advertisement system can be less efficient when comparing the money spent with the effect of the advertisement.

### SUMMARY

A method of providing consumer-targeted advertisement information through a mobile network is illustrated with the present invention. A consumer-targeted advertisement information includes receiving a plurality of advertisement information from one or more advertisers and pre-storing the advertisement information in a storage, the advertisement information including sale information of a product or service, receiving a first request from a consumer via a mobile device connected to the network for downloading an advertisement application, transmitting the advertisement application to the mobile device through the mobile network, storing consumer information in the storage, generating first consumer-targeted advertisement information by filtering the plurality of advertisement information based on the stored consumer information, and transmitting the first consumer-targeted advertisement information to the mobile device.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 illustrates an overview of the relationship between the advertiser, advertisement provider, and the consumer.

FIG. 2 shows a diagram of the network components and their respective interconnections used in the embodiments of the invention.

FIG. 3 illustrates a diagram of a computing environment capable of being adapted to perform the operations of the advertising system by the advertisement provider, according to the embodiments of the invention.

FIG. 4 illustrates a diagram of a computing environment capable of being adapted to perform the operations of the advertising system by the consumer, according to the embodiments of the invention.

FIG. 5 is a flowchart illustrating the steps performed by the advertisement provider to operate the advertising system according to an embodiment of the invention.

FIG. 6 is a flowchart illustrating the steps performed by the advertisement provider to operate the advertising system according to another embodiment of the invention.

FIG. 7 shows a scene from a website or a mobile device application according to an embodiment of the invention.

FIG. 8 illustrates an overview of the relationship between the advertiser, advertisement provider, and the consumer according to another embodiment of the present invention.

FIG. 9 is a flowchart illustrating the steps performed by the advertisement provider to operate the advertising system according to an embodiment of the present invention.

FIG. 10 illustrates an overview of the relationship between advertiser 1, advertiser 2, advertisement provider, and the consumer according to an embodiment of the present invention.

FIG. 11 is a flowchart illustrating the steps performed by the advertisement provider to operate the advertising system according to an embodiment of the present invention.

FIG. 12 shows a scene from a website or an application on a mobile device illustrating the advertisement system according to an embodiment of the present invention.

It should be understood that these figures depict embodiments of the invention. Variations of these embodiments will be apparent to persons skilled in the relevant art(s) based on the teachings contained herein. For example, the flowcharts contained in these figures depict particular operational flows. However, the functions and steps contained in these flowcharts can be performed in other sequences, as will be apparent to person skilled in the relevant art(s) based on the teachings contained herein.

### DETAILED DESCRIPTION OF THE INVENTION

Generally, it is hard for an advertiser advertising their product to advertise to a known individual or a group of people. Moreover, there has been a need to advertise to a specific target to advertise a product. In other words, advertisers usually do not have access to who their advertisement is advertised to.

Furthermore, the advertisers will have to pay a lot of advertisement fees to advertisement providers in order to have their advertisement on the newspaper, magazine, website, an application on a mobile device, or any other network medium. As a result of spending a lot of money on advertisement, the price of the product could go up and thus the consumer may have to pay more for the product.

However, the present invention provides a method to solve such problems where the advertisers do not have to pay for the advertisement or just a nominal amount to the advertisement providers. The consumers will have to purchase the advertisement program or the right to use the advertisement program from the advertisement providers. The consumer will then purchase the product directly from the advertiser and receive a benefit which includes sales information from the advertiser by using the advertisement coupon provided to the consumers by the advertisement provider. The advertiser can save money by not having to pay the advertisement provider with the advertisement fee but instead provide the consumers with a benefit on their product such as a discount or sale by issuing coupons or certificates. In such a system, the advertiser can benefit in that they will have direct access to where their advertisement is targeted and with the saved advertisement fee, they can provide consumers with more benefits and lowering the price of the product or service. The advertisement providers can receive benefit such as money by selling their advertisement program or the right to use their advertisement program or the advertisement application to the consumers. The consumers can also benefit by purchasing the advertisement application or the right to use the advertisement application provided by the advertisement provider because they may receive a benefit from the advertisers on their products, the benefit being more valuable to the consumers even if they have to purchase the advertisement application or the coupon on the advertiser's product or service.

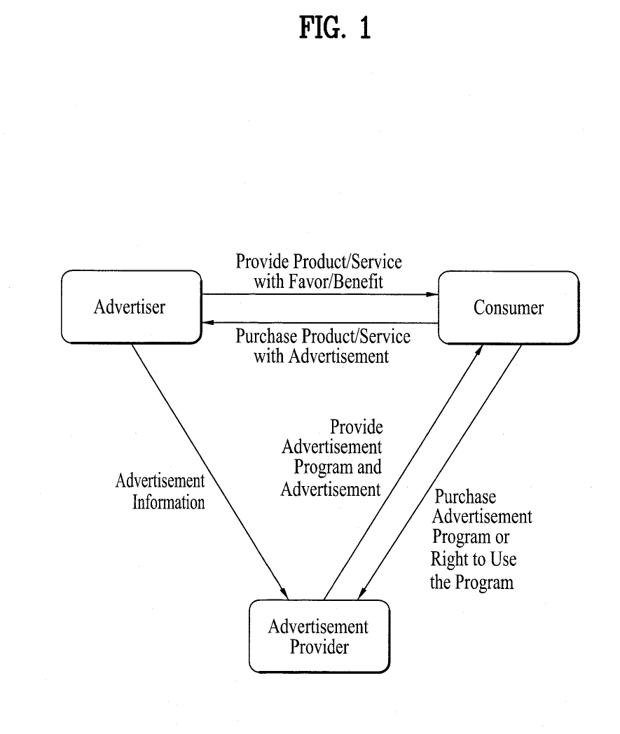

FIG. 1 illustrates an overview of the relationship between the advertiser, the advertisement provider, and the consumer according to the first embodiment of the present invention. First of all, advertiser provides their advertisement information to the advertisement provider. The advertisement provider receives the advertisement information from the advertisers. In one embodiment, there can be many different advertisers connected to the advertisement provider's network server and the advertiser provider may receive plurality of advertisement information. Then, upon consumer's request to download the advertisement application, the advertisement provider will transmit the advertisement application to the consumer. In an embodiment of the present invention, the advertisement application is an application ran on a smartphone (e.g. iPhone or Android-based smartphones). The advertisement application may also be a web-based internet site, an application able to operate on various mobile devices, or it may also be an independent program able to operate on a computer or internet web-based devices. The advertisement can be uploaded by the advertiser at anytime or updated on regular basis. In the embodiment of the present invention, the consumer, in order to view the advertisement, needs to purchase the advertisement program or the right to use the advertisement program from the advertisement provider. In an alternative embodiment, the consumer may be able to purchase individual coupon for the product or service that the consumer is willing to benefit from such as buying the product or ordering a service. When the consumer purchases the advertisement application by submitting payment to the advertisement provider, the consumer will then be able to download the advertisement program or the advertisement application. Alternatively, the in case of consumers purchasing individual coupons, the application may be downloaded for free. The advertisement application can also be in a form of a subscription, so when a consumer subscribes to use the advertisement application by paying for the advertisement application, the consumer will be able to receive the sale information, discount information, and coupon to purchase a product or a service for a discounted amount. After downloading the advertisement application or before downloading the advertisement application, the consumer will have to provide with the consumer information to the advertisement provider through their mobile device. The consumer information may included any one of the followings and not limited to the list: age, gender, occupation information, interests, hobby, home and office addresses, marital information, children information, and so forth.

The consumer, after purchasing the coupon including sale information of the advertiser's product, then can go to the advertiser's store and purchase the product by showing the coupon that they received from the advertisement provider through the advertisement application.

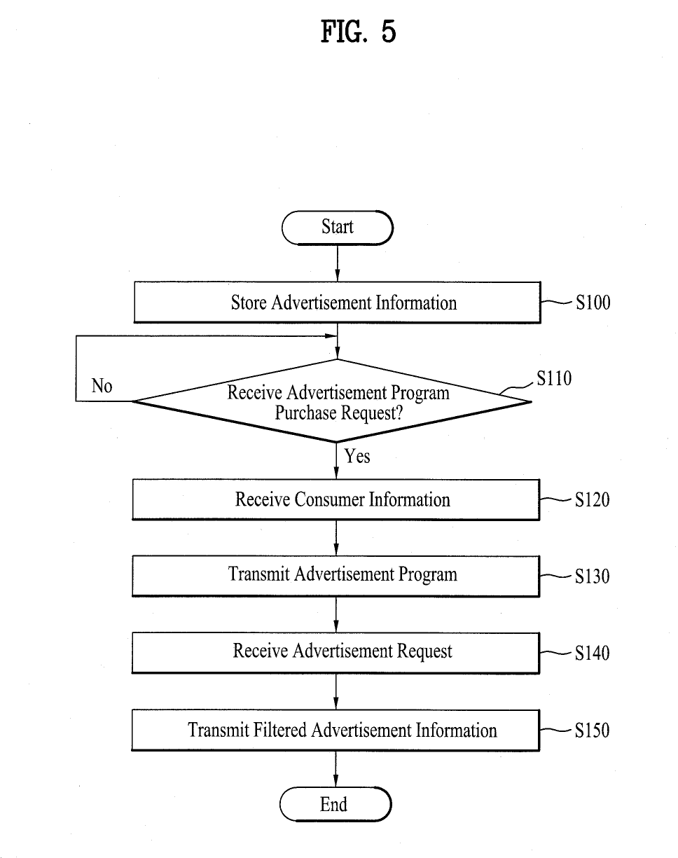

Examples of the advertisement system will be explained in detail with FIGS. 5, 6, 9, and 11.

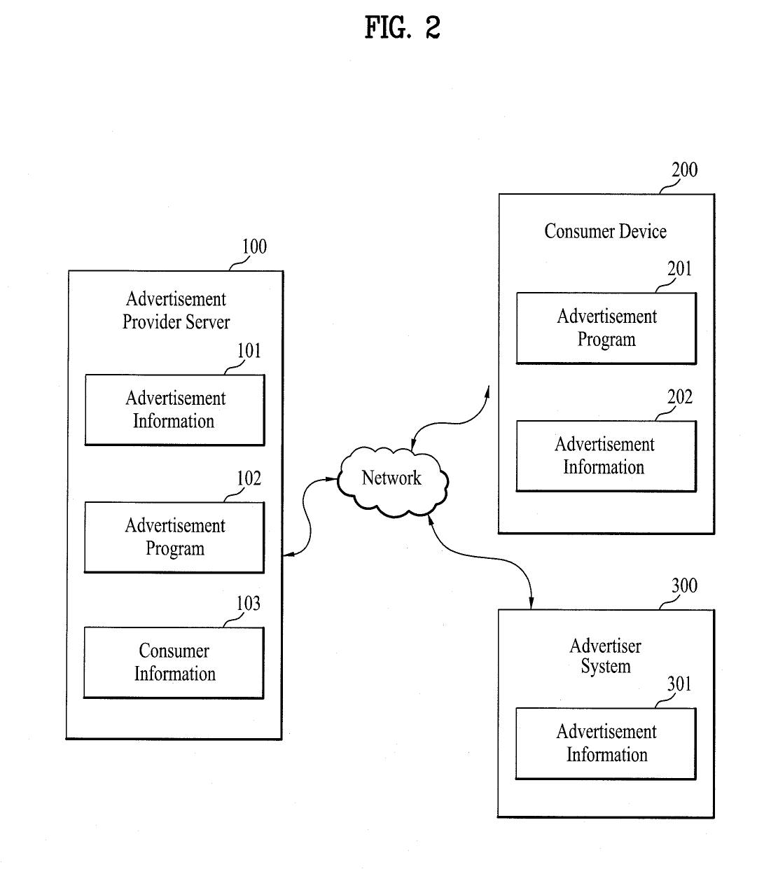

FIG. 2 shows elements of the advertisement system of the present invention. The advertisement provider has a server 100 connected through the network that includes advertisement Information 101, the advertisement program or the advertisement application 102, and the consumer information 103. The advertiser system 300 is also connected through the network. The advertiser system includes advertisement information 301 that is transmitted via the network to the advertisement provider server. On the consumer side, the consumer has a consumer device 200 that includes the advertisement program or the advertisement application 201 and the advertisement information 202. The consumer device 200 may be any one of the following—computer, mobile device such as smartphones, mobile pad devices, and so forth.

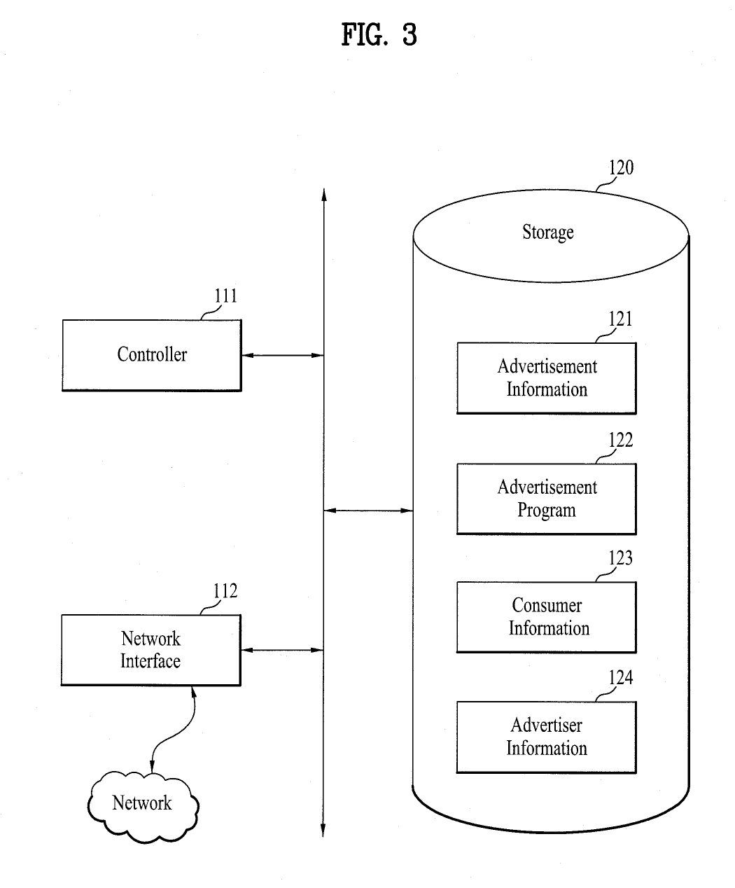

FIG. 3 illustrates a computing environment capable of being adapted to perform the operations of the advertising system by the advertisement provider, according to the embodiments of the invention. The advertisement provider system includes a controller 111 and a network interface 112 which is connected to the network, a storage 120 which includes the advertisement information 121, advertisement program 122, consumer information 123, and the advertiser information 124. The controller 111 controls the operation of the advertisement system. The controller 111 receives advertisement information from the advertiser and stores in the storage 120. The controller 111 also stores advertisement application that is to be provided to the consumer. When consumers register with the advertisement application, the consumer information 123 is stored in the storage 120 as well. The advertisement application server also includes advertisement information 124. As for the network interface 112, it is connected to the network through LAN, wireless communication such as 3G, 4G, Wi-Fi, and virtual may comprise of any communication channels. The advertisement information 124 can be in the form of still-image pictures, moving-image pictures, video-clips, texts, and so forth. The consumer information 123 can be filtered accordingly to target a specific individual or a group. For instance, the advertiser advertising lady handbags will want to show their advertisement only to female consumers in the ages from 30-40. This can be done since the advertisement provider can send specific advertisements to specific individual or a group of consumers according to an embodiment of the present invention.

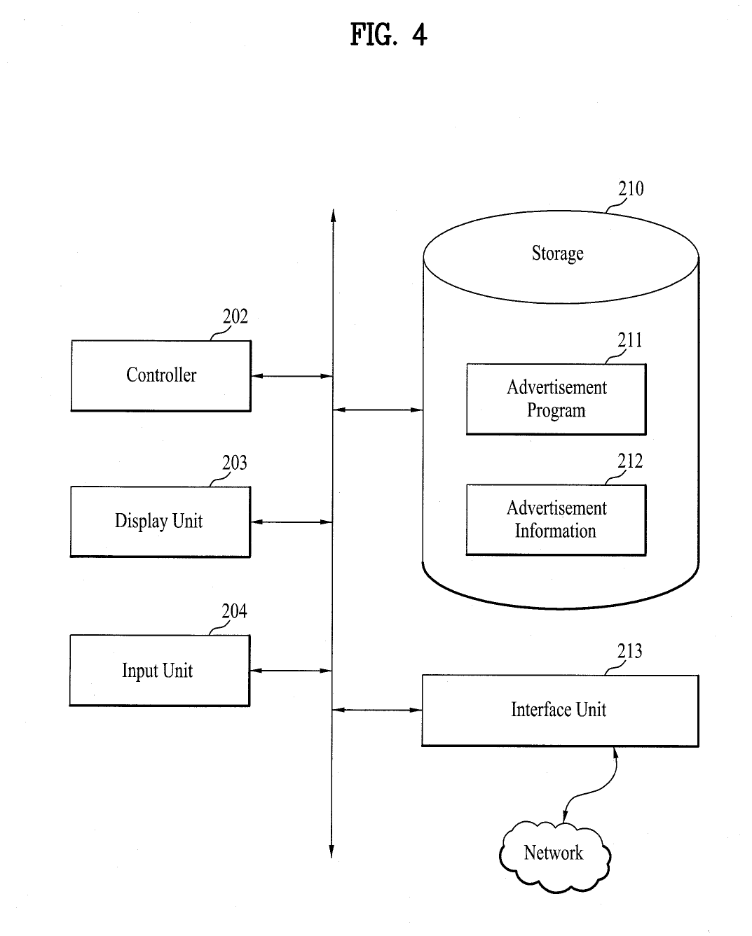

FIG. 4 illustrates a computing environment from the consumer side. The consumer device includes a controller 202, a display unit 203, an input unit 204, a storage 210 which includes an advertisement program or advertisement application 211, the advertisement information 212, and an interface unit 213 that is connected to the Network. The consumer device can be any one of a computer, a mobile telecommunication device such as a smartphone, or any device capable of receiving information through network communication. The consumer device includes a storage 210 where the advertisement program or the advertisement application 211 is stored. The stored advertisement application displays the advertisement information through the display 203. The consumer views the advertisement information and selects through the input unit 204 to view the details if desired. When the advertiser provides the advertisement information through the advertisement application, the consumer device receives the advertisement through the interface unit 212 via the Network. Updated advertisement information is displayed on the consumer device and then the consumer selects and controls the advertisement. The controlling of the advertisement information can include saving the advertisement information in the consumer device for future use or deleting the advertisement so that the consumer does not have to view the same advertisement again. The controlling of the advertisement can include various other features not just including the explanation provided herein.

FIG. 5 is a flow process of how the advertisement system is operated in the advertisement provider system. First of all, advertisement information is stored in the advertisement provider's server S100. The advertisement information can be uploaded to the advertisement provider's server directly from the advertiser or it can be automatically updated by the advertiser. Next, when a consumer decides to purchase the advertisement program, the advertisement provider receives purchase request S110. Then the consumer purchases the advertisement program by submitting payment to the advertisement provider. There are many different ways to pay for the advertisement program through the web banking system, mobile banking system, and even through offline. After when the consumer decides to purchase the advertisement program, the advertisement provider gathers consumer Information S120 such as age, sex, occupation, hobby, interest, address, and so forth. This information is stored in advertisement provider's server and can be used to filter according to advertiser's request. After the consumer successfully registers with the advertisement provider, the advertisement program is transmitted to the consumer S130. After finishing transmitting the advertisement program, the consumer requests to receive advertisement that the consumer is interested S140. This can be done through various ways as well. For example, a consumer wishes to find a sandwich store near his office. The consumer will filter the advertisement by address, category (food—sandwich), and price range. If there are any advertisements that fit the search, the advertisement information of the specific sandwich store or stores will be transmitted to the consumer's advertisement program and displayed S150. Then the consumer may choose an advertisement he intends to receive benefit and use the advertisement at the sandwich store by showing the advertisement coupon or information received from the advertisement provider at the store.

In an alternative embodiment, a method of providing consumer-targeted advertisement information is provided. First, more than one advertisement information from one or more advertisers is received by the advertisement provider. Then, the advertisement provider pre-stores the advertisement information. The advertisement information includes product or service advertisement materials such as the advertiser's price information and discount information. In other words, the advertiser will transmit their sales information to the advertisement provider so to attract the consumers from purchasing their coupon or certificate.

The consumer on the other hand, using their mobile device, will download the advertisement application after requesting to the advertisement provider. At this time, the advertisement application or the advertisement provider will require consumers to input information such as age, gender, occupation, hobby, interests, marital status, home and work addresses, and other basic consumer information. The advertisement provider will then store such consumer information in their server.

Next, the advertisement provider can generate a consumer-targeted advertisement information by filtering the plurality of advertisement information based on the consumer information stored in the advertisement server. For example, if a consumer is male, income information, interested in sports, and has a hobby of playing golf, the advertisement provider will filter from the plurality of advertisement information stored in the advertisement provider's server for golf advertisement. Then, if advertisement information matches with the consumer information, that advertisement is sent to the consumer's mobile device.

Likewise, in a different embodiment, the advertiser can also target the consumer by filtering through the consumer information. The advertisement provider, after receiving the consumer information, may send the consumer information to the advertiser. In an example, if a consumer is a female, age between 20 and 30, has an office job, and is interested in fashion. Then that consumer information is sent to the advertiser through the advertisement provider. Then the advertiser will filter through their advertisement and send appropriate advertisement information to the consumer through the advertisement provider.

In yet another embodiment of the present invention, a prior search history, consumer purchase history information, and the current location of the consumer can be used to target a consumer with the right advertisement information. For example, if a consumer, through the advertisement application, searched for golf courses in prior use of the advertisement application. And in some cases, the consumer bought tee times through the advertisement application. Then, the advertisement provider and/or the advertiser can filter their advertisement information for golf courses providing discounted green fees located near the consumer's current location.

In yet in an alternative embodiment of the present invention, the advertiser may request to the advertisement provider to transmit their advertisement information to the consumer if the consumer matches with the pre-defined group that the advertiser requested. In an example, if the advertiser is an pen manufacturer selling luxury pen, the advertiser may request to the advertisement provider to send their coupon for luxury pen to consumers in the age between 40-50, earning more than certain amount in a year, and interested in office accessories. In such a case, the advertiser can target specific consumers, providing the consumers to see their advertisement information.

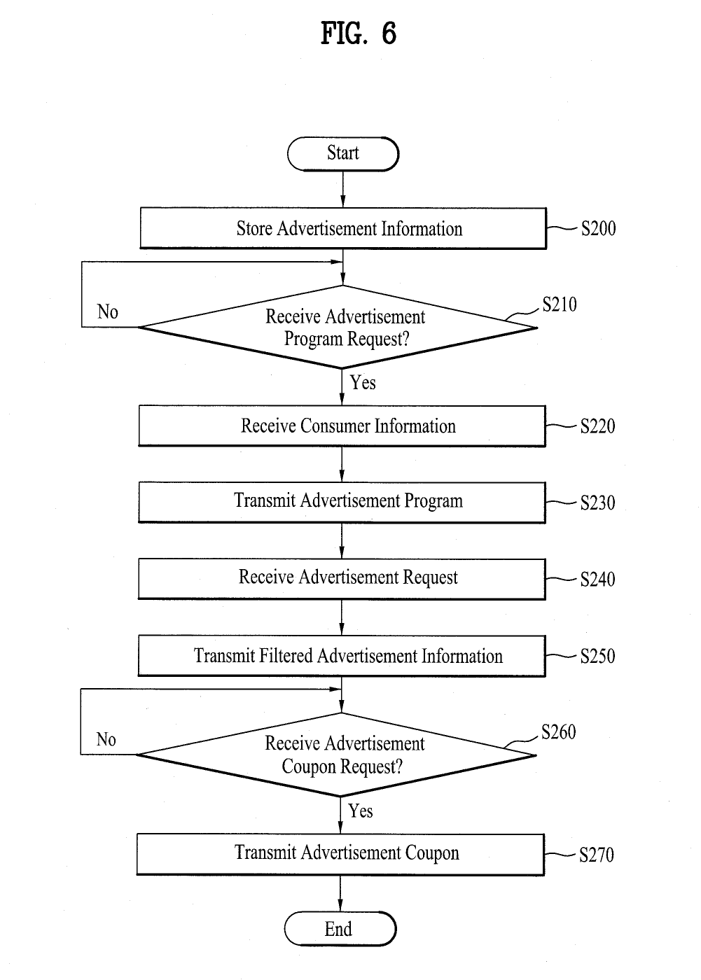

FIG. 6 is a flow process of how the advertisement system works according to another embodiment of the present invention. First, the advertisement provider stores advertiser's advertisement S200. When the consumer wishes to receive the advertisement provider's advertisement program S210, the consumer sends its information to the advertisement provider S220.

After receiving the consumer information, the advertisement provider transmits the advertisement program to the consumer S230. After installing the advertisement program, the consumer filters the advertisement or requests for advertisement depending upon the needs of the consumer S240. Then if there are advertisements that match with the consumer's need, the advertisement will be transmitted to the consumer S250. At this point, if the consumer decides to use the advertisement, the consumer will request to the advertisement provider to purchase the advertisement coupon. After receiving the advertisement coupon purchase request S260, the advertisement coupon that enables the consumer to use the advertisement is transmitted to the consumer S270.

An example according to the embodiment is as follows. In this embodiment, the consumer submits its information to the advertisement provider and downloads the advertisement program freely. The consumer then searches for advertisement according to the consumer's need. If the consumer is looking for a sandwich store nearby the consumer's office, the consumer inputs the address, the category (food—sandwich), and the price range if the consumer has a set price range.

The advertisement provider provides advertisement according to the consumer's need. If there is a match for the consumer's need, the advertisement provider transmits the advertisement to the consumer. At this point, if the consumer wishes to purchase the advertisement coupon to use it at the sandwich store, the consumer purchases the advertisement coupon. The advertisement program may use a point system where the consumer purchases points from the advertisement program. The consumer then purchases the advertisement coupon by using the points the consumer has and downloads the advertisement coupon. The points can always be recharged at the consumer's request. In this example, the consumer may use individual advertisements by using the advertisement program and purchasing the advertisement coupon according to his or her need. The points can be based on individual advertisement coupon or it can be based on duration. For example, the consumer may purchase a monthly pass where he can use to purchase any number of the advertisement coupons for a month. The duration can be a month, six months, a year, or any durational term. Also, the consumer may elect to purchase the advertisement coupon on individual basis. As explained above, downloading the advertisement program and using the advertisement program can be done in various ways such as through the website, mobile device applications (iTunes, Android Market, and other places where applications are sold). And the consumers can use the advertisement program to receive benefit by purchasing advertisement coupons.

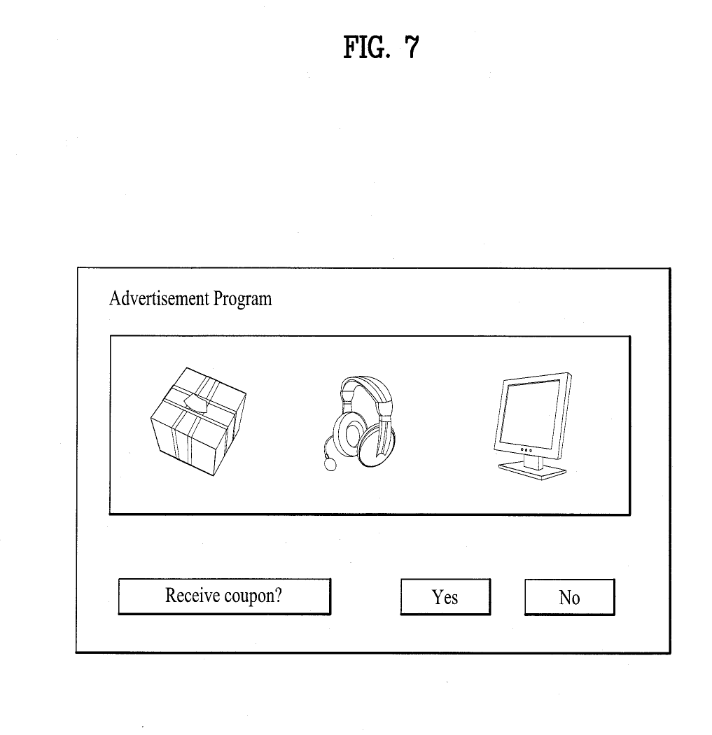

FIG. 7 is an illustration of how an advertisement can be shown in the advertisement program. It is for illustrative purposes only and other ways of displaying the advertisement is also possible. When the consumer likes a product that is currently being viewed, the consumer can click on the product icon for more details. In a different embodiment, the consumer may also purchase individual advertisements rather than buying the advertisement program.

In either way, the consumer may search for an advertisement based on the need of the consumer as explained above.

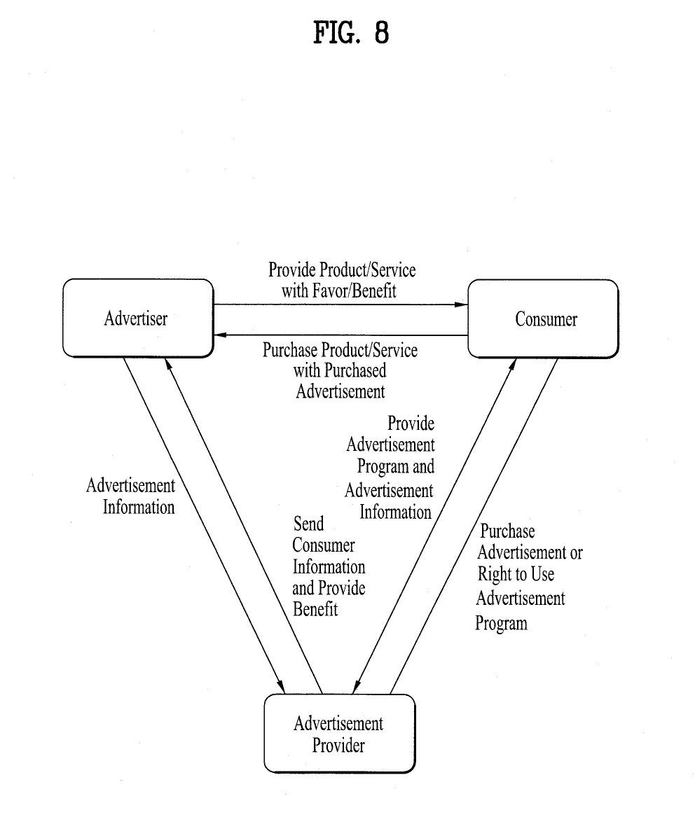

FIG. 8 illustrates a relational diagram of the advertiser, advertisement provider, and consumer in another embodiment according to the present invention. Here, the consumer purchases the individual advertisement coupons and the advertisement provider may provide a rebate according to the total number of advertisement coupons sold. When the consumer purchases an advertisement coupon, the advertisement provider keeps a count of the advertisement coupons sold. Then, the advertisement provider provides the consumer information to the advertiser. Moreover, if the consumers purchase a certain number of advertiser's advertisement, the advertisement provider provides a rebate if that certain number is more than a number that the advertisement provider and the advertiser has agreed on.

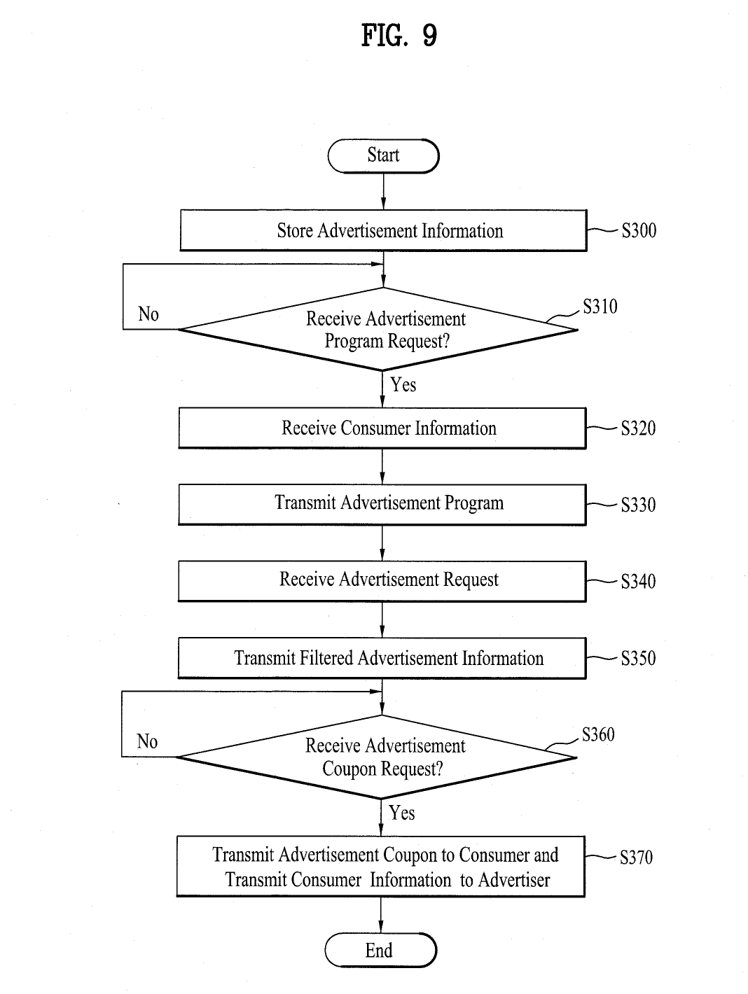

Example of this embodiment will be given in detail with explanation of FIG. 9. Through this relationship between the advertiser, the advertisement provider, and the consumer, the advertiser will benefit by selling more advertisement coupons to the consumer.

FIG. 9 shows the flow process of an embodiment of the present invention. The advertisement provider stores the advertisement information in its server S300. The consumer request to receive the advertisement program and the advertisement provider receives the request from the consumer S310. Then, the advertisement provider receives the consumer Information S320 and transmits the advertisement program to the consumer S330. The consumer then searches for the advertisement that the consumer wishes to use S340. Using the same method as FIG. 6, the advertisement provider transmits the filtered advertisement information S350.

If the consumer wishes to purchase the advertisement coupon, the advertisement provider receives the request from the consumer S360. Then the advertisement provider transmits the advertisement coupon after receiving the payment from the consumer and also sends the information to the advertiser so that the advertiser knows about the purchase S370.

An example of this embodiment is as follows. If the consumer is looking for a sandwich store near the consumer's office, the consumer goes through the steps explained above to search for the sandwich store. After finding the sandwich store advertisement that the consumer likes, the consumer purchases the advertisement coupon from the advertisement provider. Here, the purchase can be done through various methods explained above such as using points. After the consumer purchases the advertisement coupon, the advertisement provider sends the information to the advertiser so that the advertiser knows that a consumer has purchased their advertisement coupon. A number could be given on the advertisement coupon to keep track of the advertisement.

The consumer then goes to the sandwich store and provides the coupon and purchases the sandwich according to the advertisement. This record is stored in the advertisement provider's server and when a certain number of advertisements are sold for a specific advertiser, a rebate may be given to the advertiser from the advertisement provider to promote better advertisement. In this system, the advertiser will try to provide the consumer with more benefit so that more consumers will purchase their advertisement coupon. On the same line, if more advertisements are sold, the advertisement provider will make more profit. And in order to provide an incentive to the advertisers, the advertisement provider will provide a rebate to the advertiser if a certain number of advertisement coupons are sold. Therefore, the advertiser, the advertisement provider, and the consumer will all benefit from the system.

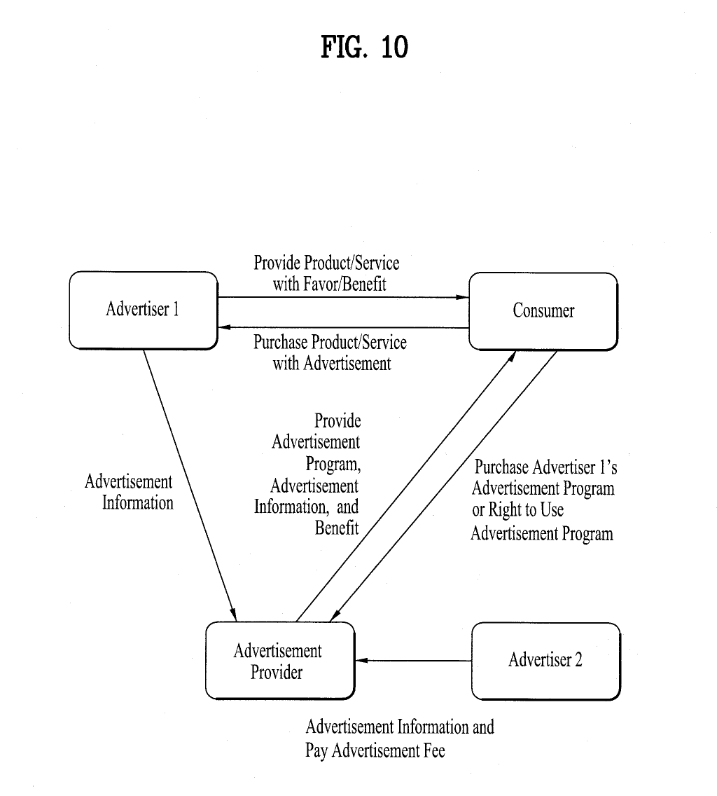

FIG. 10 illustrates relational diagram of the Advertising system for another embodiment of the present invention. In this embodiment, there are two advertisers, advertiser 1 and advertiser 2. Advertiser 1 is the main advertiser advertising their product. The advertiser 1 provides advertisement Information to the advertisement provider. The advertisement provider freely transmits the advertisement program to the consumer. However, in this embodiment, advertiser 2 also advertises their product to the consumers through the advertisement program or the advertisement application.

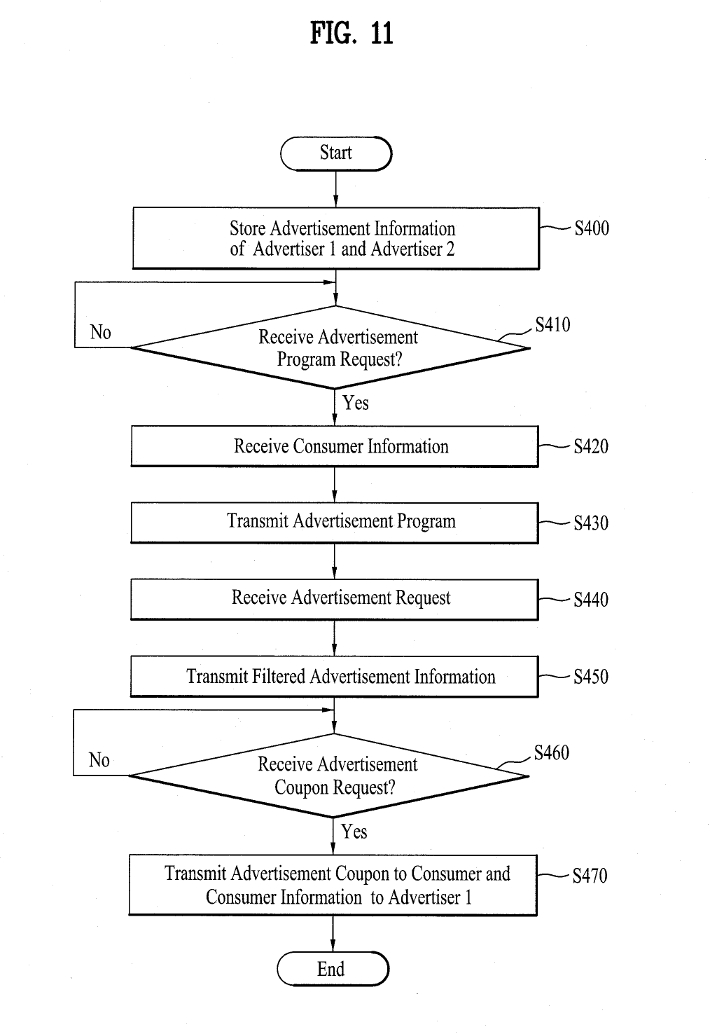

Advertiser 1 has no relationship with advertiser 2 and the product or service of advertiser 1 and advertiser 2 is not related. The advertisement by advertiser 2 may be in a form of a banner advertisement or a small display in the advertisement provider's program. Here, advertiser 2 pays an advertisement fee to the advertisement provider for having their advertisement on the program. Then the advertisement provider provides a benefit to the consumers by giving away points to use the advertisement program so that the consumer can purchase the advertisement coupons provided by advertiser 1. In this system, nothing is changed among the advertiser 1, the advertisement provider, and the consumer. Only change made by this relationship is that the advertisement provider is receiving payment from advertiser 2 by having advertiser 2's advertisement embedded in their program. And with the benefit provided from advertiser 2, the advertisement provider provides benefit to the consumers. In other words, the consumer does not have to purchase the advertisement program or points to buy the advertisement coupon with their own points because the advertisement provider will give points to the consumers. The consumers can use the points received from the advertisement provider to purchase the advertisement coupons. The points can be separated depending on “free points” given by the advertisement provider or normal “points” purchased by the consumers. Example of this embodiment will be given with explanation of FIG. 11.

FIG. 11 is a flow process explaining the embodiment of FIG. 10. The advertisement provider stores advertiser 1 and advertiser 2's advertisement Information S400. When the consumer requests for the advertisement program S410, the advertisement provider receives the consumer Information from the consumer S420. Then, the advertisement provider transmits the advertisement program with advertiser 2's advertisement embedded in the advertisement program S430.

The consumer request to search for the advertisement that the consumer desires S440 and the advertisement provider transmits the filtered advertisement from advertiser 1's advertisements S450. At this time, the advertisement provider also provides points to the consumer based on the advertisement fee, a benefit, received from advertiser 2. When the consumer wishes to purchase advertiser 1's advertisement coupon S460, the consumer may purchase the advertisement coupon with the points provided by the advertisement provider.

Finally, the advertisement provider transmits the advertisement coupon to the consumer and also transmits the purchased information to advertiser 1 S470. An example of this embodiment is as follows. The consumer wishes to locate a sandwich store located nearby the consumer's Office. The consumer provides the consumer Information and receives the advertisement program provided by the advertisement provider. The advertisement program includes an advertisement of advertiser 2. The advertiser 2 for example can be a mobile device manufacturer. The advertisement program provides an advertisement of the advertiser 2's mobile device. Since the advertiser 2 is advertising its product in the advertisement program, an advertisement fee is given to the advertisement provider by advertiser 2. With this advertisement fee, the advertisement provider gives away points to the consumers. The consumer with the points received from the advertisement provider can purchase the sandwich store advertisement coupon. The advertisement coupon for the sandwich store is provided to the consumer. The consumer can go to the sandwich store and receive the benefit of the advertisement by providing the advertisement coupon. The sandwich store is also provided the consumer information and the purchase information so that they are aware of the advertisement coupon sold. In this embodiment, nothing has changed for advertiser 1 and its relationship with the advertisement provider and the consumer. However, the consumer is benefited in this system because they receive free points to purchase the advertisement coupon. The advertisement provider also is benefited because they receive advertisement fees from advertiser 2. With the fee received, the advertisement provider gives points to the consumer accordingly. The advertiser 2 benefits from its advertisement by their advertisement being embedded in the advertisement program and being advertised. Furthermore, based on the consumer Information, advertiser 2 can target their advertisement. For instance, an automobile manufacturer can have their advertisement embedded in the advertisement program for male consumers and a handbag manufacturer can embed their advertisement on advertisement program for female consumers.

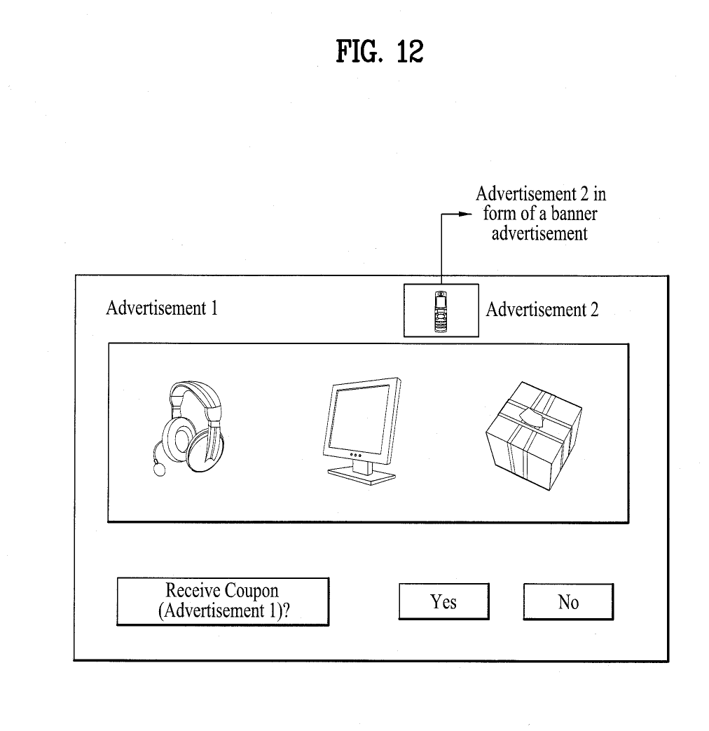

Lastly, FIG. 12 shows an exemplary scene displaying advertisement 1 and advertisement 2. Here, the advertiser 2's advertisement is in a banner form or it could be in any form as long as the advertisement can be viewed by the consumer. Again, in this embodiment, consumer gets points which could be used to purchase advertisements because advertiser 2 is providing advertisement fee to the advertisement provider and the advertisement provider provides points to the consumer based on the advertisement fee received from advertiser 2's advertisement. And the consumer after receiving advertisement information that they requested, then can purchase the advertisement coupon of advertiser 1's advertisement to be used at advertiser 1's store or service.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined above.

What is claimed is:

1. A method of providing consumer-targeted advertisement information via a mobile network, the method comprising:
receiving a plurality of advertisement information from one or more advertisers and pre-storing the advertisement information in a storage, the advertisement information including sale information of a product or service;
receiving a first request from a consumer via a mobile device connected to the network for downloading an advertisement application;
transmitting the advertisement application to the mobile device through the mobile network;
storing consumer information in the storage;
generating first consumer-targeted advertisement information by filtering the plurality of advertisement information based on the stored consumer information; and
transmitting the first consumer-targeted advertisement information to the mobile device.

2. The method of claim 1, wherein the consumer information is included in the consumer request.

3. The method of claim 1, wherein the consumer information includes at least one of gender, occupation, hobby, interest, age, marital status, income information and home address which are received from the consumer.

4. The method of claim 1 further comprising transmitting the consumer information to one of the advertisers.

5. The method of claim 4 further comprising:
receiving second user-targeted advertisement information which is generated by the advertiser based on the consumer information; and
transmitting the second user-targeted advertisement information to the mobile device.

6. The method of claim 1, wherein the consumer information includes prior search history information of the consumer.

7. The method of claim 1, wherein the consumer information includes prior purchase information of the consumer.

8. The method of claim 7, wherein the prior purchase information is obtained from the advertisers.

9. The method of claim 1, wherein the consumer information includes a current location of the consumer.

10. The method of claim 1, wherein the consumer information includes a search request made by the consumer.

11. The method of claim 1, wherein the pre-stored advertisement information is updated periodically.

12. The method of claim 1, further comprising:
receiving a second request from the consumer for purchasing an electronic savings coupon; and
transmitting the electronic savings coupon to the mobile device.

13. The method of claim 12 further comprising storing purchase information of the coupon in the storage.

14. The method of claim 12 further comprising transmitting purchase information of the coupon to an advertiser associated with the coupon.

15. An apparatus of providing consumer-targeted advertisement information via a mobile network, the apparatus comprising:
a storage storing consumer information and a plurality of advertisement information which are generated by one or more advertisers, the advertisement information including sale information of a product or service;
a mobile interface unit connected to the mobile network for communicating with a mobile device of a consumer connected to the mobile network; and
a controller transmitting an advertisement application to the mobile device when a request is made by the consumer, generating first consumer-targeted advertisement information by filtering the plurality of advertisement information based on the stored consumer information, and transmitting the first consumer-targeted advertisement information to the mobile device.
